(19) United States
(12) Patent Application Publication
(10) Pub. No.: US 2024/0301657 A1
(43) Pub. Date: Sep. 12, 2024

(54) TRAVEL SYSTEM FOR WORK MACHINE AND METHOD FOR CONTROLLING WORK MACHINE

(71) Applicant: KOMATSU LTD., Minato-ku, Tokyo (JP)

(72) Inventors: Takuya SONODA, Minato-ku, Tokyo (JP); Takeshi KAMIMAE, Minato-ku, Tokyo (JP); Yoshihide NAKAE, Minato-ku, Tokyo (JP); Youichirou KIMURA, Minato-ku, Tokyo (JP); Takashi MAEDA, Minato-ku, Tokyo (JP)

(73) Assignee: KOMATSU LTD., Minato-ku, Tokyo (JP)

(21) Appl. No.: 18/284,163

(22) PCT Filed: Jan. 19, 2022
(86) PCT No.: PCT/JP2022/001788

§ 371 Date: Sep. 26, 2023

(30) Foreign Application Priority Data
Mar. 29, 2021 (JP) 2021-055234

(51) Int. Cl. E02F 9/20; E02F 9/26

(52) U.S. Cl. CPC E02F 9/2045; E02F 9/26

(57) ABSTRACT

A travel system for a work machine is provided that can facilitate recording of courses actually traveled by the work machine. A travel system for a motor grader includes a traveling apparatus and a controller. The traveling apparatus prompts the motor grader to travel. The controller prompts automatic recording of an actually traveled course which is a course actually traveled by the motor grader.

### TECHNICAL FIELD

This disclosure relates to a travel system and a control method for a work machine.

### BACKGROUND ART

U.S. Pat. No. 8,060,299 (PTL 1) describes an automated steering system configured to generate a course of a motor grader and prompt the motor grader to travel along the generated course.

### CITATION LIST

### Patent Literature

PTL 1: U.S. Pat. No. 8,060,299

### SUMMARY OF INVENTION

### Technical Problem

In order to change a course under steering depending on the condition of a work site, an operation to store a course every time is required. This operation is, however, burdensome.

This disclosure proposes a travel system and a control method for a work machine that can facilitate recording of a course actually traveled by the work machine.

### Solution to Problem

This disclosure describes a travel system for a work machine, including a traveling apparatus and a controller. The traveling apparatus prompts the work machine to travel. The controller controls the travel system in a manner that an actually traveled course actually travelled by the work machine is automatically recorded.

### Advantageous Effects of Invention

The travel system and control method of this disclosure may successfully facilitate recording of a course actually traveled by the work machine.

### BRIEF DESCRIPTION OF DRAWINGS

FIG. 1 is a lateral view that schematically illustrates a configuration of a work machine according to an embodiment of this disclosure.

FIG. 2 is a diagram that illustrates an exemplified configuration of a travel system for the work machine of FIG. 1.

FIG. 3 is a block diagram of functional blocks of a controller illustrated in FIG. 2.

FIG. 4 is a schematic plan view of automated recording of a travel course and a travel under automated steering according to a first embodiment.

FIG. 5 is a schematic plan view of automated recording of a travel course and a travel under automated steering according to a second embodiment.

FIG. 6 is a schematic plan view of automated recording of a travel course and a travel under automated steering according to a third embodiment.

FIG. 7 is a schematic plan view of automated recording of a travel course and a travel under automated steering according to a fourth embodiment.

FIG. 8 is a schematic plan view of automated recording of a travel course and a travel under automated steering according to a fifth embodiment.

FIG. 9 is a lateral view that schematically illustrates a configuration of a work machine according to a sixth embodiment.

FIG. 10 is a schematic plan view of automated recording of a travel course and a travel under automated steering according to the sixth embodiment.

### DESCRIPTION OF EMBODIMENTS

Embodiments are hereinafter described in detail referring to the accompanying drawings. In the description below and the accompanying drawings, identical or similar components are simply illustrated with the same reference signs, redundant description of which may be skipped. For illustration purpose, a component may be illustrated in a simplified manner or may be left unillustrated.

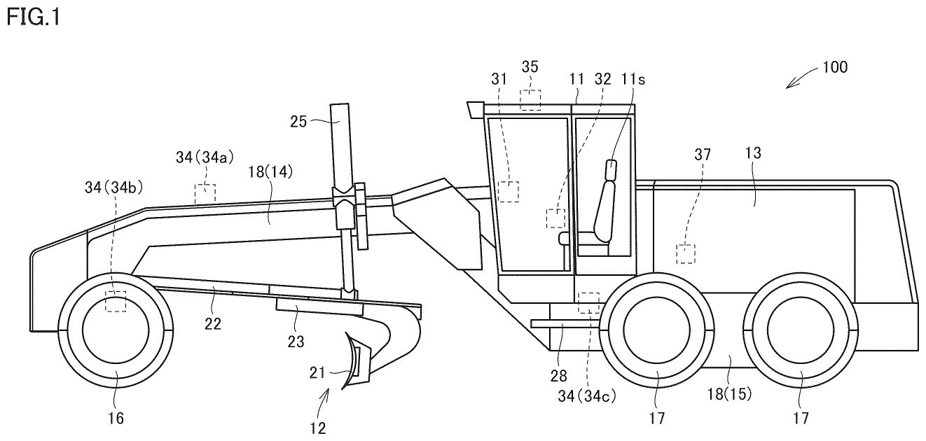

In the description below, directional terms that indicate “upper side”, “lower side”, “front side”, “rear side”, “left side” and “right side”, refer to directions based on an operator seated in an operator's seat 11S in an operator's cab 11 illustrated in FIG. 1.

### First Embodiment

### <Work Machine>

First, a motor grader 100; an example of a work machine used in this embodiment, is hereinafter described with reference to FIG. 1. Motor grader 100 is a work machine that performs an operation, while being driven to travel, for example, land grading or snow clearing. FIG. 1 is a lateral view that schematically illustrates a configuration of motor grader 100, an example of the work machine according to the embodiment of this disclosure.

As illustrated in FIG. 1, motor grader 100 includes a front frame 14, a rear frame 15, a pair of left and right articulate cylinders 28, an operator's cab (cab) 11, an engine cover 13, front wheels 16, rear wheels 17, and a work implement 12.

Front frame 14 and rear frame 15 form a body frame 18 of motor grader 100. Front frame 14 is disposed on the front side relative to rear frame 15. Front frame 14 is pivotally coupled to rear frame 15 with center pins not illustrated in the drawing.

Articulate cylinders 28 are disposed in a pair on lateral sides across body frame 18. Articulate cylinders 28 are hydraulic cylinders extendable and contractible under hydraulic pressure. The telescopic motion of articulate cylinders 28 allow front frame 14 to pivot around a vertically extending axis relative to rear frame 15.

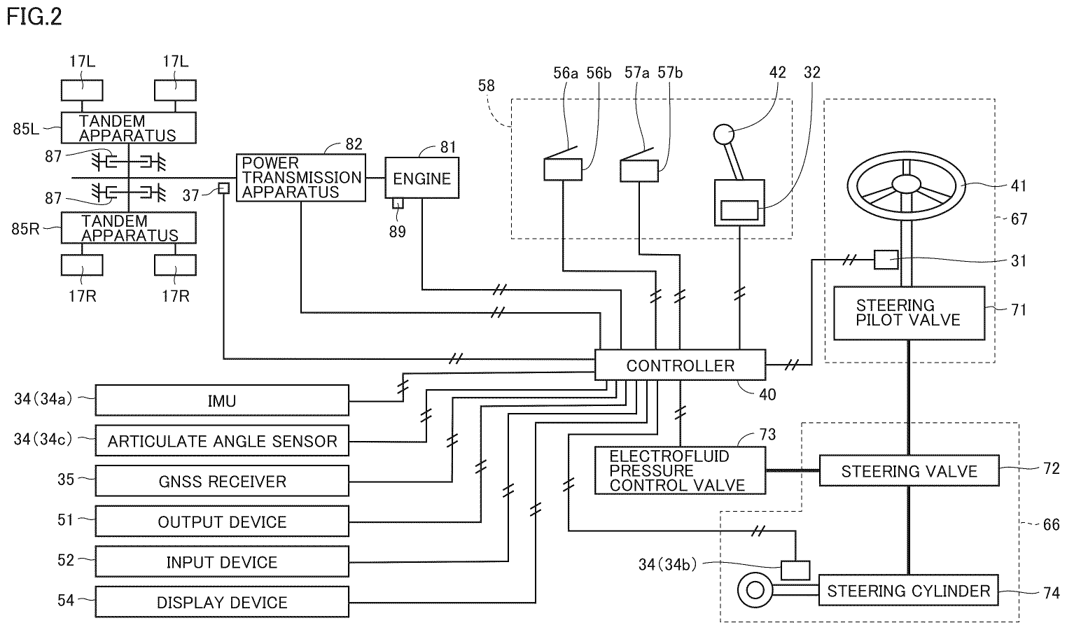

Engine cover 13 is used to cover an engine compartment and is supported by rear frame 15. In the engine compartment are disposed, for example, an engine 81 and a power transmission apparatus 82 (FIG. 2), and a structure for exhaust treatment.

Front wheels 16 and rear wheels 17 are running wheels. Front wheels 16 are pivotally attached to front frame 14. Front wheels 16 are steering wheels and are attached to front frame 14 in a steerable manner. Rear wheels 17 are pivotally attached to rear frame 15. A driving force transmitted from engine 81 is conveyed to rear wheels 17. Front wheels 16 and rear wheels 17 configure a traveling apparatus that prompts motor grader 100 to travel according to the embodiment disclosed herein.

Work implement 12 is disposed at a position in a fore/aft direction between front wheels 16 and rear wheels 17. Work implement 12 is supported by front frame 14. Work implement 12 incudes a blade 21, a drawbar 22, a swing circle 23, and a pair of lift cylinders 25. Motor grader 100 is allowed to perform operations, using blade 21, including land grading and snow clearing and may also serve as light cutting tools and material mixing tools.

Drawbar 22 is disposed below front frame 14. The front end of drawbar 22 is coupled in a swingable manner to a distal end of front frame 14. Paired lift cylinders 25 are disposed on lateral sides across front frame 14. The rear end of drawbar 22 is supported by front frame 14 through paired lift cylinders 25.

In response to the telescopic motion of paired lift cylinders 25, the rear end of drawbar 22 is allowed to move upward and downward relative to front frame 14. The height of blade 21 relative to front frame 14 and front wheels 16 is adjustable by the telescopic motion of paired lift cylinders 25. As paired lift cylinders 25 are extendable and contractible in different manners, drawbar 22 is allowed to swing upward and downward around an axis extending in the fore/aft direction.

Swing circle 23 is disposed at a position below drawbar 22. Swing circle 23 is coupled to drawbar 22 in a swingable manner. Swing circle 23 is allowed to swing clockwise and counterclockwise around an axis extending in a vertical direction.

Blade 21 is disposed below swing circle 23. Blade 21 is disposed so as to face the ground. Blade 21 is supported by swing circle 23. Blade 21 is allowed to swing in response to the swing motion of swing circle 23, with the angle of blade 21 relative to the fore/aft direction when viewed from the upper side (blade propulsive angle) being changeable. The axis of swing of blade 21 is an axis extending in the vertical direction.

As illustrated in FIG. 1, motor grader 100 further has a handle sensor 31, an operating lever sensor 32, a direction sensor 34, and an FNR/vehicle speed sensor 37.

Handle sensor 31 detects the handling operation of steering handle 41 (FIG. 2) by an operator. Handle sensor 31 may be, for example, an axis displacement sensor that detects angle changes of the steering handle's axis that occur in response to the rotation of steering handle 41.

Operating lever sensor 32 detects the handling operation of an operating lever 42 (FIG. 2) by the operator. Operating lever sensor 32 may be, for example, a position sensor that detects the angular position of operating lever 42.

Direction sensor 34 detects a direction in which body frame 18 of motor grader 100 is currently positioned. Direction sensor 34 may be, for example, one of an IMU (Inertial Measurement Unit) 34a, a steering angle sensor 34b, and an articulate angle sensor 34c, or may be two more of these sensors optionally selected and combined.

IMU 34a may be attached to, for example, front frame 14. IMU 34a may be, for example, a hexaxial IMU. The hexaxial IMU is a combined sensor installed with a triaxial accelerator and a triaxial gyroscope (angle, angular rate or angular acceleration). The hexaxial IMU is attachable to front frame 14 so that these three axes respectively extend along the fore/aft direction, a lateral direction and the vertical direction of the work machine. In this instance, the hexaxial IMU is operable to detect positional changes along the axes in the fore/aft direction, lateral direction and vertical direction, and angular changes around these axes (i.e., work machine's rolling, pitching and yawing).

IMU34a may be, for example, a nine-axis IMU. The nine-axis IMU is a combined sensor installed with a triaxial accelerator, a triaxial gyroscope and a triaxial magnetometer. The nine-axis IMU, which measures geomagnetism using the triaxial magnetometer, may more effectively control any gyroscopic drift than the hexaxial IMU.

Any changes in direction of motor grader 100 may be accurately known based on the acceleration and gyroscopic data detected by IMU 34a. IMU 34a may be attached to rear frame 15 or operator's cab 11.

Steering angle sensor 34b may be attached to, for example, a steering cylinder 74 (FIG. 2). Steering angle sensor 34b detects the steering angle of front wheels 16 (angle made by front wheels 16 to the direction of extension of front frame 14).

Articulate angle sensor 34c may be attached to, for example, articulate cylinder 28. Articulate angle sensor 34c detects an articulate angle (a coupling angle) of front frame 14 and rear frame 15.

FNR/vehicle speed sensor 37 is disposed in a power transmission path through which a driving force of engine 81 is transmitted to rear wheels 17. FNR/vehicle speed sensor 37 may be attached to, for example, a gear box (see power transmission apparatus 82 of FIG. 2). FNR/vehicle speed sensor 37 detects the statuses of motion; forward (F), reverse (R) and neutral (N) and also detects the vehicle speed of traveling motor grader 100.

Motor grader 100 utilizes a satellite positioning system. The satellite positioning system may employ, for example, GNSS (Global Navigation Satellite System). When the GNSS is employed as the satellite positioning system, motor grader 100 includes a GNSS receiver 35. The antenna of GNSS receiver 35 may be, for example, installed in the ceiling of operator's cab 11. GNSS receiver 35 receives positioning signals from the satellites. The satellite positioning system obtains the position of the antenna of GNSS receiver 35 through a computing process using the positioning signals received by GNSS receiver 35 to generate position data and orientation data of motor grader 100. The position and orientation of motor grader 100 in the earth-based global coordinate system can be measured and known by using the satellite positioning system.

### <Travel System>

Next, a travel system according to this embodiment is hereinafter described with reference to FIG. 2. FIG. 2 is a diagram that illustrates an exemplified configuration of a travel system for the work machine of FIG. 1. The system according to this embodiment includes motor grader 100; an example of the work machine illustrated in FIG. 1, and a controller 40 illustrated in FIG. 2. Controller 40 may be mounted to motor grader 100. Controller 40 may be mounted to a device or equipment on the outside of motor grader 100. Controller 40 may be located at a work site of motor grader 100 or a remote area away from the work site of motor grader 100.

Motor grader 100 according to this embodiment is a rear drive vehicle in which the driving force of engine 81 is transmitted to rear wheels 17 (left rear wheel 17L and right rear wheel 17R) so that rear wheels 17 are driven as driving wheels. Engine 81 is supported by rear frame 15.

The driving force of engine 81 is transmitted to rear wheels 17 by way of power transmission apparatus 82, e.g., torque converter or gear box, a final drive not illustrated in the drawing, and tandem apparatuses 85L and 85R disposed on the left and right. A pair of left rear wheels 17L is connected to tandem apparatus 85L. A pair of right rear wheels 17R is connected to tandem apparatus 85R.

A service brake 87 is provided on the upstream side of tandem apparatus 85L, 85R in the power transmission path from engine 81 to left rear wheels 17L and right rear wheels 17R. Service brake 87 is used to decelerate traveling motor grader 100 to lower its traveling speed.

Motor grader 100 includes a travel/stoppage operating unit 58 and a steering operating unit 67 that are disposed in operator's cab 11. Travel/stoppage operating unit 58 and steering operating unit 67 are operated by the operator mounted on operator's cab 11.

Travel/stoppage operating unit 58 is operated by the operator to prompt motor grader 100 to travel or stop. Travel/stoppage operating unit 58 includes a forward/backward operating apparatus, an acceleration operating apparatus, and a braking operating apparatus. The forward/backward operating apparatus has operating lever 42 and operating lever sensor 32. The acceleration operating apparatus has an acceleration pedal 56a and an acceleration operation detector 56b. The braking operating apparatus has a brake pedal 57a and a braking operation detector 57b.

Operating lever 42 is operated by the operator to be leaned to change the statuses of motion of motor grader 100 to and from forward (F), reverse (R) and neutral (N). Operating lever 42 is allowed to shift to and from a forward position (F position) that prompts motor grader 100 to move forward, a reverse position (R position) that prompts motor grader 100 to move backward, and a neutral position (N position) that leaves motor grader 100 to stay neutral. The N position may be at an intermediate position between the F position and the R position.

Operating lever sensor 32 detects the operation of operating lever 42 by the operator. Operating lever sensor 32 may be, for example, a position sensor that detects the angular position of operating lever 42. Detection signals of operating lever sensor 32 are outputted, as electrical signals, to controller 40.

Acceleration pedal 56a is operated by the operator to set a target rate of revolution of engine 81. Acceleration operation detector 56b detects the operation of acceleration pedal 56a by the operator. Acceleration operation detector 56b outputs, to controller 40, a detection signal that indicates the operation amount of acceleration pedal 56a. The operator operates acceleration pedal 56a to control the rate of feed of fuel to engine 81, thereby controlling the number of revolutions of engine 81.

The number of revolutions of engine 81 is detected by an engine revolution sensor 89. Engine revolution sensor 89 outputs, to controller 40, a detection signal that indicates the number of revolutions of engine 81.

Brake pedal 57a is operated by the operator to set a braking force required of motor grader 100. Braking operation detector 57b detects the operation of brake pedal 57a by the operator. Braking operation detector 57b outputs, to controller 40, a detection signal that indicates the operation amount of brake pedal 57a. Service brake 87 is driven in response to brake pedal 57a being operated by the operator. The braking force of service brake 87 is adjustable in accordance with the operation amount of brake pedal 57a.

Though not illustrated in the drawings, the gear box of power transmission apparatus 82 may have plural gear positions for the forward position and also for the reverse position to allow the operator to select an optional gear position of the gear box. In this instance, travel/stoppage operating unit 58 includes a selector to select one of the gear positions (not illustrated in the drawing).

Steering operating unit 67 is operated by the operator to activate a steering mechanism 66. Steering operating unit 67 includes handle sensor 31, steering handle 41 and a steering pilot valve 71.

Steering handle 41 may have, for example, a wheel-like shape and is operated to rotate by the operator. Handle sensor 31 detects the operation of steering handle 41 by the operator. Handle sensor 31 may be, for example, an axis displacement sensor that detects angle changes of the steering handle's axis that occur in response to the rotation of steering handle 41. Detection signals of handle sensor 31 are outputted, as electrical signals, to controller 40.

Steering pilot valve 71 feeds a steering valve 72 with a pilot oil in response to the rotational operation of steering handle 41.

Steering mechanism 66 is a mechanism to operate the direction of travel of motor grader 100. Steering mechanism 66 has steering valve 72, steering cylinder 74, and steering angle sensor 34b.

Steering valve 72 is controllable depending on the pilot oil fed from an electrofluid pressure control valve 73 and steering pilot valve 71. Thus, steering valve 72 controls the direction and rate of flow of the hydraulic oil fed to steering cylinder 74.

Steering cylinder 74 is extendable and contractible in response to the feed of hydraulic oil into a cylinder oil chamber through steering valve 72. The steering angle of front wheels 16 changes in response to the telescopic motion of steering cylinder 74.

Controller 40 controls electrofluid pressure control valve 73 based on detection signals of handle sensor 31. Thus, steering cylinder 74 is extendable and contractible in response to the operation of steering handle 41 by the operator, and the steering angle of front wheels 16 accordingly changes.

When front wheels 16 are leaned rightward relative to the direction of extension of front frame 14, motor grader 100 changes its direction of travel, starting to move forward to the right. When front wheels 16 are leaned leftward relative to the direction of extension of front frame 14, motor grader 100 changes its direction of travel, starting to move forward to the left.

Motor grader 100 is operable to travel under manual steering. Under manual steering, motor grader 100 travels in accordance with the operations of travel/stoppage operating unit 58 and of steering operating unit 67 by the operator.

Motor grader 100 is also operable to travel under automated steering. Under automated steering, the steering of motor grader 100 is automatically controlled by controller 40. Controller 40, using the satellite positioning system, obtains the position and orientation of motor grader 100 in the earth-based global coordinate system. The operator sets a target travel course during traveling under automated steering. Controller 40 automatically controls electrofluid pressure control valve 73, so that a direction headed by motor grader 100 follows the target travel course set by the operator. Steering valve 72 is thus automatically controlled, and steering cylinder 74 is also automatically controlled, which allows automatic control of the steering angle of front wheels 16. Travel/stoppage operating unit 58 is operated by the operator, and the steering angle of front wheels 16 is automatically controlled by controller 40, which allows motor grader 100 to travel under automated steering.

Electrical signals are inputted to controller 40 from direction sensor 34, GNSS receiver 35 and FNR/vehicle speed sensor 37. An output device 51, an input device 52 and a display device 54 are electrically connected to controller 40. Output device 51, input device 52 and display device 54 will be described later in detail.

### <Functional Blocks of Controller 40>

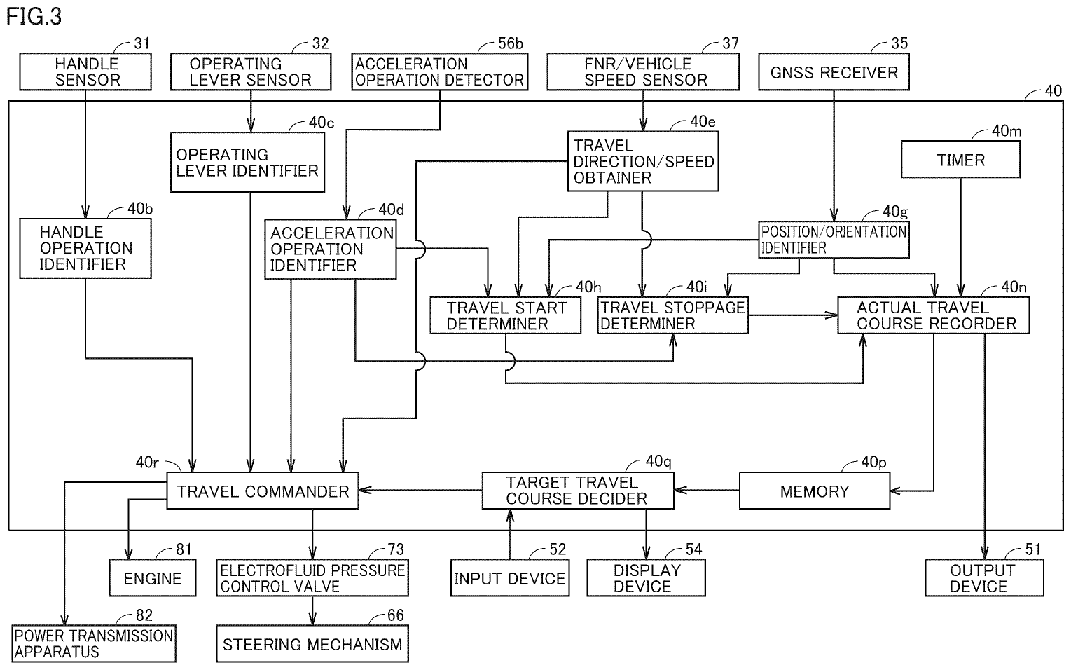

Next, functional blocks of controller 40 are described below with reference to FIG. 3. FIG. 3 is a block diagram of functional blocks of controller 40 illustrated in FIG. 2.

As illustrated in FIG. 3, handle sensor 31 measures, for example, the amount of rotation of steering handle 41. A handle operation identifier 40b identifies the direction and amount of operation of steering handle 41 based on the amount of operation measured by handle sensor 31.

An operating lever identifier 40c obtains, from operating lever sensor 32, a detection signal that indicates the operation of operating lever 42. Operating lever identifier 40c identifies, based on the obtained detection signal, whether operating lever 42 is currently at the forward position (F position), reverse position (R position) or neutral position (N position).

An acceleration operation identifier 40d obtains a signal from acceleration operation detector 56b and identifies the operation amount of acceleration pedal 56a by the operator.

Handle operation identifier 40b outputs the direction and amount of operation of steering handle 41 to a travel commander 40r. Operating lever identifier 40c outputs the position of operating lever 42 (F position, R position or N position) to travel commander 40r. Acceleration operation identifier 40d outputs the operation amount of acceleration pedal 56a to travel commander 40r.

Travel commander 40r outputs a control signal to electrofluid pressure control valve 73 based on the direction and amount of operation of steering handle 41. Travel commander 40r outputs a control signal to engine 81 and power transmission apparatus 82 based on the current status of operating lever 42 and the operation amount of acceleration pedal 56a. Thus, motor grader 100 is able to travel under the operation by the operator

A travel direction/speed obtainer 40e obtains, from FNR/vehicle speed sensor 37, a detection signal that indicates the traveling status of motor grader 100; forward (F), reverse (R) or neutral (N), and the vehicle speed of the traveling motor grader 100.

A position/orientation identifier 40g is an element that constitutes the satellite positioning system, which identifies the position data and orientation data of motor grader 100 based on the positioning signals received by GNSS receiver 35. The position data of motor grader 100 identified by position/orientation identifier 40g represents a position of motor grader 100 defined in the global coordinate system. The orientation data of motor grader 100 identified by position/orientation identifier 40g is data defined in the global coordinate system, which represents an orientation marked by the front side of motor grader 100 (for example, north, south, east, west).

A travel start determiner 40h detects a start of travel of motor grader 100 based on at least one of the following; the operation amount of acceleration pedal 56a identified by acceleration operation identifier 40d, vehicle speed of motor grader 100 and forward or reverse movement or neutral position of motor grader 100 obtained by travel direction/speed obtainer 40e, and the position data and orientation data of motor grader 100 identified by position/orientation identifier 40g.

Travel start determiner 40h may determine the start of travel of motor grader 100 when motor grader 100 is detected as starting to travel forward in response to receipt of a signal input that indicates the position of operating lever 42 from operating lever identifier 40c and a signal input that indicates the operation amount of acceleration pedal 56a from acceleration operation identifier 40d. Travel start determiner 40h may determine the start of travel of motor grader 100 when motor grader 100 is detected as starting to travel backward. Travel start determiner 40h may determine the start of travel of motor grader 100 when motor grader 100 shifts its movement to and from forward movement and backward movement.

Travel start determiner 40h may read a threshold of the traveling speed of motor grader 100 from a memory 40p, receive a signal input that indicates the current traveling speed of motor grader 100 from travel direction/speed obtainer 40e, and compare the current traveling speed of motor grader 100 to the threshold. Then, travel start determiner 40h may determine the start of travel of motor grader 100 when the result of this comparison indicates that the current traveling speed of motor grader 100 is greater than or equal to the threshold.

Travel start determiner 40h may read a threshold of the moving distance of motor grader 100 from memory 40p, receive a signal input that indicates the position data of motor grader 100 from position/orientation identifier 40g, and calculate the moving distance of motor grader 100 from the position data of motor grader 100 at a halt and the current position data of motor grader 100. Then, travel start determiner 40h may determine the start of travel of motor grader 100 when the result of this comparison indicates that the moving distance of motor grader 100 is greater than or equal to the threshold.

Travel start determiner 40h may determine the start of travel of motor grader 100 when the acceleration rate of motor grader 100 detected by IMU 34a is found to be greater than or equal to a threshold.

A travel stoppage determiner 40i detects the stoppage of travel of motor grader 100 based on at least one of the following; the operation amount of acceleration pedal 56a identified by acceleration operation identifier 40d, vehicle speed of motor grader 100 and forward or reverse movement or neutral position of motor grader 100 obtained by travel direction/speed obtainer 40e, and the position data and orientation data of motor grader 100 identified by position/orientation identifier 40g.

Travel stoppage determiner 40i may detect the stoppage of travel of motor grader 100 based on the operation amount of brake pedal 57a. Travel stoppage determiner 40i may detect the stoppage of travel of motor grader 100 when the traveling speed of motor grader 100 falls below a threshold. Travel stoppage determiner 40i may detect the stoppage of travel of motor grader 100 when the moving distance of motor grader 100 falls below a threshold.

An actual travel course recorder 40n records, as an actually traveled course, a course actually traveled by motor grader 100 from the start to end of the travel of motor grader 100. When the start of travel of motor grader 100 is detected by travel start determiner 40h, actual travel course recorder 40n sets a position at which the travel started as a starting point of the actually traveled course. When the stoppage of travel of motor grader 100 is detected by travel stoppage determiner 40i, actual travel course recorder 40n sets a position at which the travel stopped as an ending point of the actually traveled course.

Actual travel course recorder 40n reads time points from a timer 40m. Actual travel course recorder 40n may read out a time point when motor grader 100 started to travel from timer 40m and sets a position of motor grader 100 at the time point as the starting point of the actually traveled course. Actual travel course recorder 40n may read out a time point when motor grader 100 ceased to travel from timer 40m and sets a position of motor grader 100 at the time point as the ending point of the actually traveled course.

Actual travel course recorder 40n uses the start of travel of motor grader 100 as a trigger of recording start and uses the stoppage of travel of motor grader 100 as a trigger of recording end. Actual travel course recorder 40n automatically records the actually traveled course of motor grader 100 from the start to end of the travel based on the position data and orientation data of motor grader 100 identified by position/orientation identifier 40g. For example, actual travel course recorder 40n may equally divide a length of time between time points that respectively correspond to the starting point and to the ending point of the actually traveled course and then identify the position and orientation of motor grader 100 at each time point that delimits the divided length of time. Thus, a course actually traveled by motor grader 100 during the time may be successfully recorded. If necessary, actual travel course recorder 40n may apply a smoothing process to the actually traveled course of motor grader 100.

The actually traveled course may include one or a plurality of traveling segments. When, for example, the actually traveled course includes a first traveling segment and a second traveling segment, the first traveling segment may be a course traveled by motor grader 100 moving forward, while the second traveling segment may be a course traveled by motor grader 100 moving backward. In this instance, the first traveling segment and the second traveling segment may represent the same course. This may be rephrased that a round-trip route traveled by the reciprocate motion of motor grader 100 may be recorded as the actually traveled course. The first traveling segment and the second traveling segment may be courses that differ from each other.

The first traveling segment and the second traveling segment may be both a course traveled by motor grader 100 moving forward or may be both a course traveled by motor grader 100 moving backward.

The actually traveled course recorded by actual travel course recorder 40n is stored in memory 40p. Controller 40 controls the system, so that the actually traveled course is recorded and then stored in memory 40p.

The actually traveled course recorded by actual travel course recorder 40n is also outputted to output device 51. Output device 51 may be an external computer apart from controller 40. Output device 51 may be various pieces of recording media or may be an output device such as a display or a printer. The actually traveled course stored in memory 40p may be outputted to output device 51.

A target travel course decider 40q extracts the whole or part of the actually traveled course stored in memory 40p and decides a target travel course to be traveled by motor grader 100 under automated steering. Controller 40 controls the system, so that a course actually traveled by motor grader 100 is automatically recorded and then used the recorded course actually traveled as the target travel course of motor grader 100. For instance, target travel course decider 40q may select and decide, as the target travel course, one of two or more actually traveled courses stored in memory 40p. On display device 54 is displayable the target travel course decided by target

travel course decider 40q. Display device 54 may be or may include a display monitor. Display device 54 may be allowed to display the target travel course by the length of a predetermined distance from the current position of motor grader 100. Display device 54 may be allowed to display the whole target travel course. The target travel course to be displayed on display device 54 may be switchable by an operation by the operator.

Input device 52 receives an operator's input for selection of one of the actually traveled courses stored in memory 40p as the target travel course. Examples of input device 52 may include a keyboard, mouse, and touch panel. Optionally, a touch panel in which input device 52 and display device 54 are integrated may be used. A device in which input device 52 and output device 51 are integrated may be used.

On display device 54 may be displayable two or more actually traveled courses selectable as the target travel course. An operator, by manipulating input device 52, may select one of the actually traveled courses displayed on display device 54 as the target travel course. Target travel course decider 40q may decide one of two or more actually traveled courses selectable as the target travel course, if they are stored in memory 40p, in accordance with an operator's choice.

Target travel course decider 40q may prioritize two or more actually traveled courses more suitably selectable as the target travel course. Target travel course decider 40q may notify the operator of the decided order of priority, for example, through display device 54.

Travel commander 40r, as well as control of steering mechanism 66, engine 81 and power transmission apparatus 82 during traveling under manual steering, enables motor grader 100 to travel under automated steering along the target travel course. Based on an operator's command to start the automated steering, controller 40 automatically steers motor grader 100 using the actually traveled courses stored in memory 40p set as the target travel course. For instance, controller 40 prompts motor grader 100 to travel under automated steering along one of the actually traveled courses stored in memory 40p set as the target travel course.

The operator's command to prompt motor grader 100 to start to travel under automated steering may be, for example, a command issued by the operator to move motor grader 100 backward.

With reference to FIG. 3, for instance, operating lever identifier 40c obtains a detection signal indicating that operating lever 42 is at the R position, and acceleration operation identifier 40d obtains a detection signal indicating that the operation amount of acceleration pedal 56a by the operator is greater than or equal to a predetermined operation amount. Then, operating lever identifier 40c and acceleration operation identifier 40d output to, travel commander 40r, signals indicating that motor grader 100 started to move backward. Alternatively, when travel direction/speed obtainer 40e obtains, from FNR/vehicle speed sensor 37, a detection signal indicating that motor grader 100 is moving backward and its traveling speed is greater than or equal to the threshold, travel direction/speed obtainer 40e outputs a signal indicating that motor grader 100 started to move backward, which is inputted to travel commander 40r.

Travel commander 40r which receives the signal input indicating the start to move backward motor grader 100 automatically controls electrofluid pressure control valve 73 to allow motor grader 100 to travel backward along the target travel course. Thus, motor grader 100 travels backward under automated steering.

### <Travel Course Automated Recording, Automated Steering Travel>

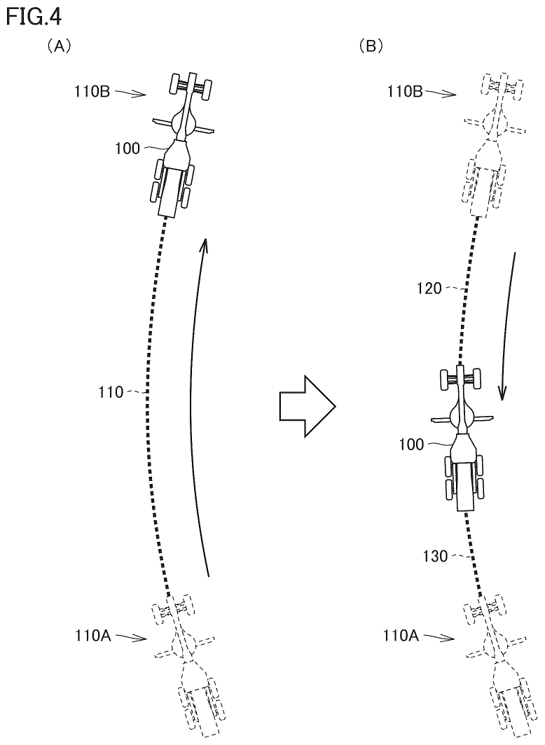

FIG. 4 is a schematic plan view of automated recording of a course actually traveled by motor grader 100 and a travel of motor grader 100 under automated steering according to the first embodiment. FIG. 4(A) is a drawing that illustrates motor grader 100 traveling under manual steering a course between a travel starting position 110A and a travel ending position 110B. An actually traveled course 110 is a course actually traveled by motor grader 100 until motor grader 100 that started to move forward at travel starting position 110A ceases to move forward at travel ending position 110B. Actually traveled course 110 is automatically recorded by controller 40 based on results of detection obtained by the sensors. Controller 40 stores, in memory 40p, actually traveled course 110 automatically recorded during travel illustrated in FIG. 4(A).

After motor grader 100 ceases to move forward, controller 40 decides actually traveled course 110 recorded during travel illustrated in FIG. 4(A) as a target travel course 130 when motor grader 100 travels backward under automated steering. As illustrated in FIG. 4(B), controller 40, based on the operator's command for start of backward movement at travel ending position 110B, prompts motor grader 100 to travel backward under automated steering from travel ending position 110B to travel starting position 110A along target travel course 130 (i.e., along actually traveled course 110 recorded during the travel illustrated in FIG. 4(A)). An actually traveled course 120 of motor grader 100 when moving backward is also automatically recorded by controller 40. Controller 40 stores, in memory 40p, actually traveled course 120 automatically recorded during travel illustrated in FIG. 4(B).

In the first embodiment, controller 40 automatically records both of actually traveled courses 110 and 120 of motor grader 100; the former being a course traveled during the forward movement, and the latter being a course traveled during the backward movement. Controller 40 automatically records both of the course actually traveled by motor grader 100 under automated steering and the course actually traveled by motor grader 100 under manual steering.

Controller 40 may record a predetermined number of actually traveled courses recorded every time when the direction of movement of motor grader 100 changes to and from forward and backward.

Controller 40 may automatically record a course actually traveled by motor grader 100 during a period earlier by a predetermined length of time than a time point when the stoppage of travel of motor grader 100 is detected. When motor grader 100 is currently not traveling, controller 40 may automatically record an entire course actually traveled by motor grader 100 up to now from a time point earlier by a predetermined length of time than a time point when traveling motor grader 100 comes to a halt. When motor grader 100 is currently traveling, controller 40 may automatically record an entire course actually traveled by motor grader 100 up to now from a time point earlier by a predetermined length of time than a time point when motor grader 100 most recently comes to a halt.

Thus, a course(s) actually traveled by motor grader 100 within a predetermined length of time may be automatically recorded as the actually traveled course. Every time when motor grader 100 stops or when the direction of movement of motor grader 100 shifts to and from forward and backward, the actually traveled course recorded earlier may be marked off and thus divided into a plurality of travelling segments and then recorded. One of these traveling segments thus recorded may be selected as the target travel course, so that motor grader 100 is driven to travel under automated steering along this target travel course.

### Second Embodiment

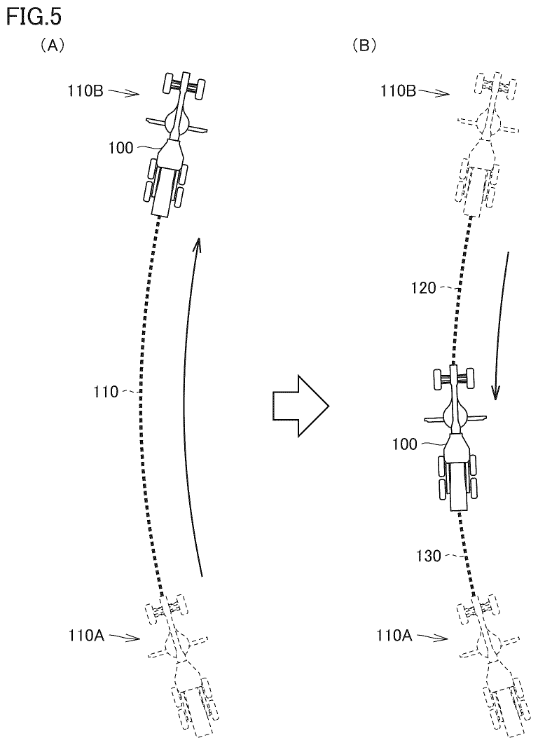

FIG. 5 is a schematic plan view of automated recording of a course actually traveled by motor grader 100 and a travel of motor grader 100 under automated steering according to a second embodiment. FIG. 5(A) is a drawing that illustrates motor grader 100 traveling under manual steering a course between travel starting position 110A and travel ending position 110B. As with the first embodiment, actually traveled course 110 is a course actually traveled by motor grader 100 until motor grader 100 that started to move forward at travel starting position 110A ceases to move forward at travel ending position 110B. Actually traveled course 110 is automatically recorded by controller 40 based on results of detection obtained by the sensors. Controller 40 stores, in memory 40p, actually traveled course 110 automatically recorded during travel illustrated in FIG. 5(A).

After motor grader 100 ceases to move forward, controller 40 decides actually traveled course 110 recorded during travel illustrated in FIG. 5(A) as target travel course 130 when motor grader 100 travels backward under automated steering. As illustrated in FIG. 5(B), controller 40, based on the operator's command for start of backward movement at travel ending position 110B, prompts motor grader 100 to travel backward under automated steering from travel ending position 110B to travel starting position 110A along target travel course 130 (i.e., along actually traveled course 110 recorded during the travel illustrated in FIG. 5(A)). Unlike the first embodiment, actually traveled course 120 of motor grader 100 when moving backward is not automatically recorded by controller 40.

In the second embodiment, controller 40 automatically records actually traveled course 110 of motor grader 100; a course traveled during the forward movement, whereas controller 40 does not automatically record actually traveled course 120 of motor grader 100; a course traveled during the backward movement. Thus, whether the traveled course should be automatically recorded may be selectively set depending on whether motor grader 100 moves forward or backward.

A target travel course 130 of motor grader 100 when traveling under automated steering illustrated in FIG. 5(B) is the same as actually traveled course 110 automatically recorded during the travel under manual steering illustrated in FIG. 5(A). Controller 40 controls motor grader 100 so that actually traveled course 120 of motor grader 100 traveling under automated steering illustrated in FIG. 5(B) overlaps with actually traveled course 110 automatically recorded during the travel under manual steering illustrated in FIG. 5(A). Therefore, controller 40 may control the system so that the actually traveled course of motor grader 100 under manual steering is automatically recorded, while the actually traveled course of motor grader 100 under automated steering is not automatically recorded.

### Third Embodiment

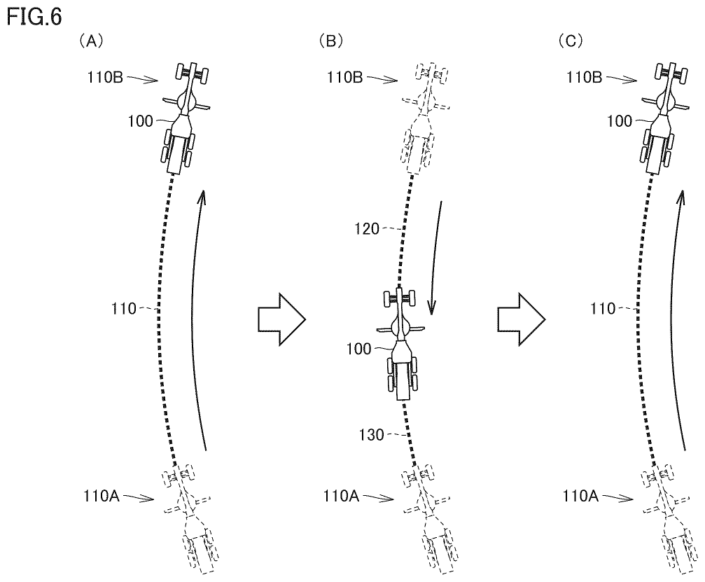

FIG. 6 is a schematic plan view of automated recording of a course actually traveled by motor grader 100 and a travel of motor grader 100 under automated steering according to a third embodiment. FIG. 6(A) is a drawing that illustrates motor grader 100 traveling under manual steering a course between travel starting position 110A and travel ending position 110B. As with the first embodiment, actually traveled course 110 is a course actually traveled by motor grader 100 until motor grader 100 that started to move forward at travel starting position 110A ceases to move forward at travel ending position 110B. Actually traveled course 110 is automatically recorded by controller 40 based on results of detection obtained by the sensors. Controller 40 stores, in memory 40p, actually traveled course 110 automatically recorded during travel illustrated in FIG. 6(A).

After motor grader 100 ceases to move forward, controller 40 decides actually traveled course 110 recorded during travel illustrated in FIG. 6(A) as target travel course 130 when motor grader 100 travels backward under automated steering. As illustrated in FIG. 6(B), controller 40, based on the operator's command for start of backward movement at travel ending position 110B, prompts motor grader 100 to travel backward under automated steering from travel ending position 110B to travel starting position 110A along target travel course 130 (i.e., along actually traveled course 110 recorded during the travel illustrated in FIG. 6(A)). As with the second embodiment, actually traveled course 120 of motor grader 100 when moving backward is not automatically recorded by controller 40.

FIG. 6(C) is a drawing that illustrates motor grader 100 traveling under manual steering a course between travel starting position 110A and travel ending position 110B, like the illustration of FIG. 6(A). The course actually traveled by motor grader 100 at the time; actually traveled course 110, is also automatically recorded by controller 40 based on results of detection obtained by the sensors.

After motor grader 100 stops the forward movement illustrated in FIG. 6(C), controller 40 compares actually traveled course 110; already automatically recorded, during the travel of FIG. 6(A) with actually traveled course 110; already automatically recorded, during the travel of FIG. 6(C). In case the result of this comparison allows controller 40 to determine that actually traveled course 110 of motor grader 100 during the travel of FIG. 6(C) overlaps, accurately enough, with actually traveled course 110 already automatically recorded during the travel illustrated in FIG. 6(A) and stored in memory 40p, controller 40 may decide not to store actually traveled course 110 during the travel illustrated in FIG. 6(C) in memory 40p.

### Fourth Embodiment

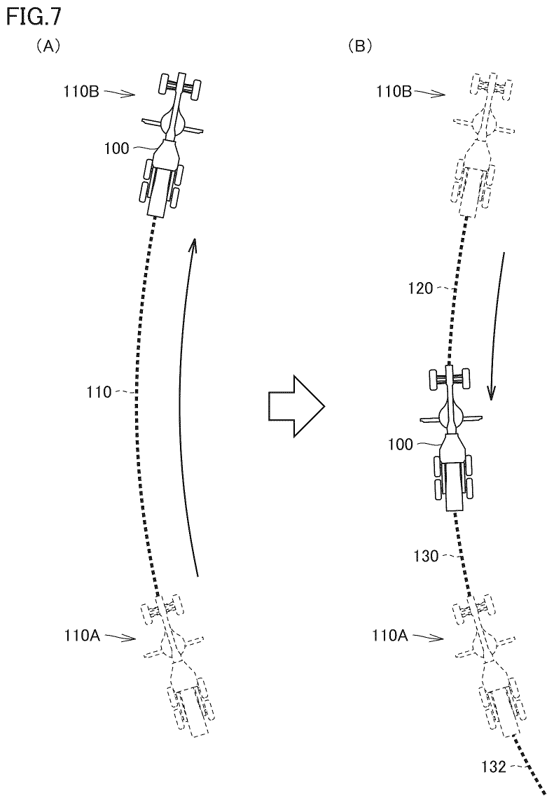

FIG. 7 is a schematic plan view of automated recording of a course actually traveled by motor grader 100 and a travel of motor grader 100 under automated steering according to a fourth embodiment. FIG. 7(A) is a drawing that illustrates motor grader 100 traveling under manual steering a course between travel starting position 110A and travel ending position 110B. As with the first embodiment, actually traveled course 110 is a course actually traveled by motor grader 100 until motor grader 100 that started to move forward at travel starting position 110A ceases to move forward at travel ending position 110B. Actually traveled course 110 is automatically recorded by controller 40 based on results of detection obtained by the sensors. Controller 40 stores, in memory 40p, actually traveled course 110 automatically recorded during travel illustrated in FIG. 7(A).

After motor grader 100 ceases to move forward, controller 40 decides actually traveled course 110 recorded during travel illustrated in FIG. 7(A) as target travel course 130 when motor grader 100 travels backward under automated steering. As illustrated in FIG. 7(B), controller 40, based on the operator's command for start of backward movement at travel ending position 110B, prompts motor grader 100 to travel backward under automated steering from travel ending position 110B to travel starting position 110A along target travel course 130 (i.e., along actually traveled course 110 recorded during the travel illustrated in FIG. 7(A)).

In case motor grader 100 continues the backward movement beyond travel starting position 110A which is the end of target travel course 130, controller 40 automatically decides an extension 132; a course resulting from extension of actually traveled course 110, as target travel course 130 of motor grader 100 after passing travel starting position 110A. In case actually traveled course 110, for example, draws an arc-shaped line as illustrated in FIG. 7(A), controller 40 extends the arc-shaped line of actually traveled course 110 and use the extended line as extension 132.

Controller 40 automatically decides target travel course 130 including extension 132 which is the extended course of actually traveled course 110. Controller 40 prompts motor grader 100 to continue to move backward under automated steering along this target travel course 130. This may avoid the risk that automated steering of motor grader 100 that arrived at travel starting position 110A stops and no longer travels against an operator's intension. Controller 40 is allowed to control the travel of motor grader 100, so that motor grader 100 continues to travel under automated steering unless the operator issues a command requesting that motor grader 100 should cease to travel by pressing brake pedal 57a and motor grader 100 discontinues to travel when the operator issues the command requesting that motor grader 100 should cease to travel.

When motor grader 100 traveling along target travel course 130 is approaching travel starting position 110A or travel ending position 110B at the end of target travel course 130, controller 40 may notify the operator that motor grader 100 is approaching the end of target travel course 130. This notice may be issued through display device 54 or may be issued in an auditory manner through, for example, voice/sound from a buzzer or a speaker.

### Fifth Embodiment

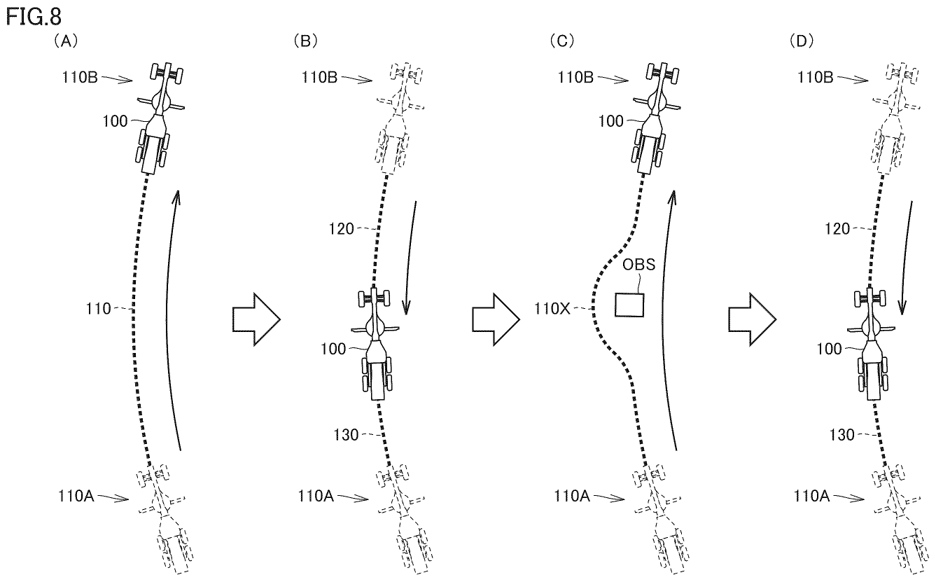

FIG. 8 is a schematic plan view of automated recording of a course actually traveled by motor grader 100 and a travel of motor grader 100 under automated steering according to a fifth embodiment. FIG. 8(A) is a drawing that illustrates motor grader 100 traveling under manual steering a course between travel starting position 110A and travel ending position 110B. As with the first embodiment, actually traveled course 110 is a course actually traveled by motor grader 100 until motor grader 100 that started to move forward at travel starting position 110A ceases to move forward at travel ending position 110B. Actually traveled course 110 is automatically recorded by controller 40 based on results of detection obtained by the sensors. Controller 40 stores, in memory 40p, actually traveled course 110 automatically recorded during travel illustrated in FIG. 8(A).

After motor grader 100 ceases to move forward, controller 40 decides actually traveled course 110 recorded during travel illustrated in FIG. 8(A) as target travel course 130 when motor grader 100 travels backward under automated steering. As illustrated in FIG. 8(B), controller 40, based on the operator's command for start of backward movement at travel ending position 110B, prompts motor grader 100 to travel backward under automated steering from travel ending position 110B to travel starting position 110A along target travel course 130 (i.e., along actually traveled course 110 recorded during the travel illustrated in FIG. 8(A)). Unlike the first embodiment, actually traveled course 120 of motor grader 100 when moving backward is not automatically recorded by controller 40.

FIG. 8(C) is a drawing that illustrates motor grader 100 traveling under manual steering a course between travel starting position 110A and travel ending position 110B. An obstacle OBS is located on actually traveled course 110 traveled by motor grader 100 in FIG. 8(A), and the operator navigates motor grader 100 under manual steering so as to avoid obstacle OBS. An actually traveled course 110X of motor grader 100 in FIG. 8(C) differs from actually traveled course 110 of motor grader 100 in FIG. 8(A). Actually traveled course 110X in FIG. 8(C) is a course actually traveled by motor grader 100 until motor grader 100 that started to move forward at travel starting position 110A ceases to move forward at travel ending position 110B. This actually traveled course 110X is automatically recorded by controller 40 based on results of detection obtained by the sensors. Controller 40 stores, in memory 40p, actually traveled course 110X automatically recorded during travel illustrated in FIG. 8(C).

In memory 40p are stored actually traveled course 110 actually traveled by motor grader 100 in FIG. 8(A) and actually traveled course 110X actually traveled by motor grader 100 in FIG. 8(C). In this instance, controller 40 selects one of actually traveled course 110 of FIG. 8(A) and actually traveled course 110X of FIG. 8(C) as the target travel course and thus decides target travel course 130 of motor grader 100 when moving backward under automated steering.

Target travel course 130 of motor grader 100 when moving backward under automated steering is thus not necessarily limited to the course most recently traveled by motor grader 100 and may instead be selected from a plurality of courses automatically recorded and stored in memory 40p by controller 40.

If obstacle OBS is still blocking or interfering with the course when motor grader 100 starts to move backward from travel ending position 110B, actually traveled course 110X of FIG. 8(C) may be selected as target travel course 130. Unless obstacle OBS is blocking or interfering with the course when motor grader 100 starts to move backward from travel ending position 110B as illustrated in FIG. 8(D), actually traveled course 110 of FIG. 8(A) may be selected as target travel course 130. The most suitable course may be flexibly set as target travel course 130 depending on conditions of the work site changing at every moment, so that motor grader 100 is allowed to successful travel under automated steering.

Controller 40 may automatically decide whether actually traveled course 110 of FIG. 8(A) or actually traveled course 110X of FIG. 8(C) should be selected as the target travel course. For example, motor grader 100 may include an imaging device allowed to capture images of the surrounding environment of motor grader 100, in which case controller 40 may determine the presence or absence of obstacle OBS based on an image(s) captured by the imaging device and then accordingly decide a suitable one of the target travel courses. Alternatively, an operator may select one of actually traveled course 110 of FIG. 8(A) and actually traveled course 110X of FIG. 8(C) that should be selected as the target travel course and then input his/her selection to controller 40 using input device 52.

### Sixth Embodiment

Thus far were described exemplified manners of traveling control with motor grader 100; an example of the work machine. The work machine is not necessarily limited to motor grader 100. The technology described herein may also be applicable to any other work machines but motor grader 100. This disclosure may be applicable to other work machines including wheel loaders, crawler dozers and forklifts which are driven to travel to perform works.

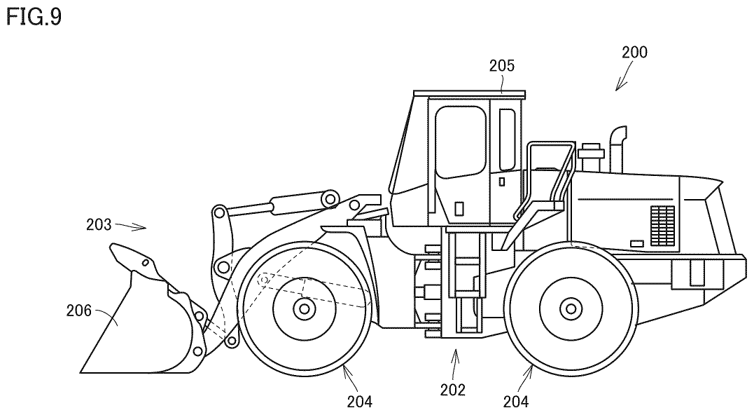

FIG. 9 is a lateral view that schematically illustrates a configuration of a wheel loader 200, an example of the work machine according to a sixth embodiment. As illustrated in FIG. 9, wheel loader 200 includes a body frame 202, work implement 203, a traveling apparatus 204, and a cab 205. Body frame 202 and cab 205 and the like constitute the body of wheel loader 200. Work implement 203 and traveling apparatus 204 are mounted to the body of wheel loader 200.

The body of wheel loader 200 is driven to travel by traveling apparatus 204. Wheel loader 200 is a self-propelled vehicle driven to travel by traveling apparatus 204 and perform any desired work using work implement 203.

Work implement 203 includes a bucket 206 which is a working tool. Bucket 206 is disposed at a tip end of work implement 203. Bucket 206 is an example of attachments constituting a tip end portion of work implement 203. Depending on what kind of work is to be performed, the attachment may be changed to, for example, grappling hook, fork, and plow.

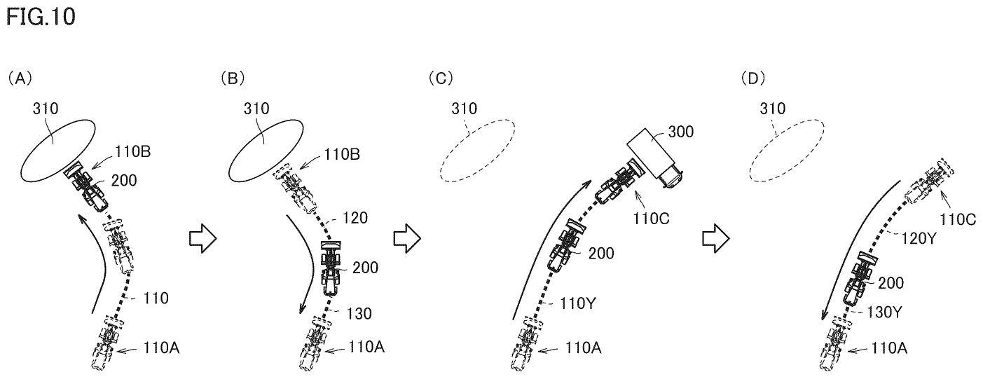

FIG. 10 is a schematic plan view of automated recording of a course actually traveled by wheel loader 200 and a travel of wheel loader 200 under automated steering according to the sixth embodiment. In FIG. 10 is illustrated wheel loader 200 that performs V-shape loading which is a typical example of works performed by wheel loaders.

FIG. 10(A) illustrates wheel loader 200 moving forward with an empty bucket. Wheel loader 200 moves forward under manual steering toward a target of excavation 310, like soil, on a course from travel starting position 110A to travel ending position 110B. Actually traveled course 110 is a course actually traveled by wheel loader 200 until wheel loader 200 that started to move forward at travel starting position 110A pushes bucket 206 into target of excavation 310 and ceases to move forward at travel ending position 110B. This actually traveled course 110 is automatically recorded by controller 40 based on results of detection obtained by the sensors. Controller 40 stores, in memory 40p, actually traveled course 110 automatically recorded during travel illustrated in FIG. 10(A).

FIG. 10(B) illustrates wheel loader 200 moving backward with a loaded bucket. Bucket 206 is loaded with target of excavation 310. After wheel loader 200 ceases to move forward, controller 40 decides actually traveled course 110 recorded during travel illustrated in FIG. 10(A) as target travel course 130 when wheel loader 200 travels backward under automated steering. Controller 40, based on the operator's command for start of backward movement at travel ending position 110B, prompts wheel loader 200 to travel backward under automated steering from travel ending position 110B to travel starting position 110A along target travel course 130 (i.e., along actually traveled course 110 recorded during the travel illustrated in FIG. 10(A)).

FIG. 10(C) illustrates wheel loader 200 moving forward with a loaded bucket. Wheel loader 200, with bucket 206 being loaded with target of excavation 310, moves forward toward a dump truck 300. Wheel loader 200 moves forward under manual steering toward dump truck 300 on a course from travel starting position 110A to a travel ending position 110C. At travel ending position 110C, wheel loader 200 is parked to load target of excavation 310 within bucket 206 into dump truck 300. An actually traveled course 110Y is a course actually traveled by wheel loader 200 until wheel loader 200 that started to move forward at travel starting position 110A ceases to move forward at travel ending position 110C. Actually traveled course 110Y is automatically recorded by controller 40 based on results of detection obtained by the sensors. Controller 40 stores, in memory 40p, actually traveled course 110Y automatically recorded during travel illustrated in FIG. 10(C).

FIG. 10(D) illustrates wheel loader 200 moving backward with an empty bucket. After wheel loader 200 ceases to move forward, controller 40 decides actually traveled course 110Y recorded during travel illustrated in FIG. 10(C) as target travel course 130 when wheel loader 200 travels backward under automated steering. Controller 40, based on the operator's command for start of backward movement at travel ending position 110C, prompts wheel loader 200 to travel backward under automated steering from travel ending position 110C to travel starting position 110A along target travel course 130 (i.e., along actually traveled course 110Y recorded during the travel illustrated in FIG. 10(C)).

In this embodiment, wheel loader 200 moves backward under automated steering along a course actually traveled by wheel loader 200 during the most recent forward movement.

### Operational Advantages and Effects

Below are described the technical features and operational advantages and effects of the embodiments of this disclosure, though some of which were described earlier.

Controller 40 prompts automatic recording of actually traveled course 110 actually traveled by motor grader 100, as illustrated in FIGS. 4 to 8 and 10. Actually traveled course 110 may be automatically recorded without requiring any particular operation by the operator to start/end the recording. This may favorably facilitate the recording of actually traveled course 110.

As illustrated in FIGS. 4 to 8 and 10, controller 40, based on the operator's command, may drive the work machine to travel under automated steering using actually traveled course 110 recorded earlier as the target travel course. This may enable automated recording of the actually traveled course of the work machine, allowing the work machine to travel under automated steering along the already traveled course in a timely manner as desired by the operator. By using the actually traveled course of the work machine as the target travel course when the work machine travels under automated steering, the work machine may be allowed to travel along a course(s) known to be safe earlier with no blockage or obstruction. Thus, a suitable course(s) to be traveled by the work machine may be selected depending on different situations and circumstances of the work site.

As illustrated in FIGS. 4 to 8 and 10, controller 40 may detect the start of travel of the work machine and set the starting point of the actually traveled course and may also detect the end of travel of the work machine and set the ending point of the actually traveled course. This may dispense with any particular operation by the operator to start/end the recording of the actually traveled course, ensuring that the recording of the actually traveled course can be automatically started.

As illustrated in FIGS. 4 to 8 and 10, controller 40 may determine the start of forward movement of the work machine as the start of travel of the work machine and then set the starting point of the actually traveled course to automatically record the actually traveled course. This may dispense with any particular operation by the operator to start the recording of the actually traveled course, ensuring that the recording of the actually traveled course can be automatically started.

As illustrated in FIG. 4, controller 40 may determine the start of backward movement of the work machine as the start of travel of the work machine and then set the starting point of the actually traveled course to automatically record the actually traveled course. This may dispense with any particular operation by the operator to start the recording of the actually traveled course, ensuring that the recording of the actually traveled course can be automatically started.

As illustrated in FIG. 3, controller 40 may determine the start of travel of the work machine when travel direction/speed obtainer 40e obtains a detection signal indicating that the traveling speed of the work machine is greater than or equal to the threshold and then set the starting point of the actually traveled course to automatically record the actually traveled course. This may dispense with any particular operation by the operator to start the recording of the actually traveled course, ensuring that the recording of the actually traveled course can be automatically started.

As illustrated in FIG. 3, when the moving distance of the work machine is known to be greater than or equal to the threshold based on the position data of motor grader 100 identified by position/orientation identifier 40g, controller 40 may determine the start of travel of the work machine and then set the starting point of the actually traveled course to automatically record the actually traveled course. This may dispense with any particular operation by the operator to start the recording of the actually traveled course, ensuring that the recording of the actually traveled course can be automatically started.

Controller 40 includes memory 40p, as illustrated in FIG. 2. Controller 40 stores, in memory 40p, the actually traveled courses automatically recorded. In case the course actually traveled by the work machine overlaps with any actually traveled course already stored in memory 40p, as illustrated in FIG. 6, controller 40 may decide not to store such an overlapping course in memory 40p. Any actually traveled courses, if they overlap with the stored courses, are not stored in memory 40p, while courses that differ from the already stored courses are selectively stored in memory 40p. Thus, the actually traveled courses automatically recorded may be more efficiently stored in memory 40p.

As illustrated in FIG. 5, controller 40 may automatically record the actually traveled courses during a period earlier by a predetermined length of time than a time point when the work machine is detected as no longer traveling. This may facilitate the process to record actually traveled courses.

As illustrated in FIGS. 4 to 8 and 10, controller 40, based on the operator's command, may drive the work machine to travel under automated steering using the actually traveled course recorded earlier as the target travel course. The actually traveled course of the work machine may be thus used as the target travel course when the work machine travels under automated steering. Then, the work machine may be allowed to travel along a suitable course(s) selected depending on conditions of the work site.

As illustrated in FIGS. 4 to 8 and 10, controller 40 may drive to travel the work machine under automated steering based on the operator's command requesting backward movement of the work machine. The work machine thus driven to travel under automated steering during the backward movement may be allowed to reliably return to its original position without a U-turn. This may reduce the cycle time and space required of the work machine's travel, allowing the work machine to improve in productivity. This may also eliminate the need for the operator to operate steering handle 41 during the backward movement, reducing the operator's fatigue.

As illustrated in FIG. 8, controller 40 may select, as the target travel course, one of the actually traveled courses stored in memory 40p. Thus, the most suitable course may be flexibly set as the target travel course depending on conditions of the work site changing at every moment. This may ensure successful automated steering of the work machine.

As illustrated in FIG. 3, the travel system may further include input device 52 that receives the operator's input for selection of one of the actually traveled courses stored in memory 40p as the target travel course. This may allow an optimal course to successfully set as the target travel course as desired by the operator.

As illustrated in FIG. 7, controller 40 may decide the target travel course including an additional course obtained by extension of the actually traveled course. This may avoid the risk that automated steering of the work machine is discontinued against the operator's intension when the work machine arrives at the start or ending position of the actually traveled course, allowing the work machine to continue to travel under automated steering until the operator's command is received, requesting that the work machine should discontinue to travel.

As illustrated in FIG. 3, the travel system may further include display device 54 on which the target travel course is displayable. An operator, viewing display device 54, may know the target travel course to be traveled hereafter under automated steering.

As illustrated in FIG. 3, the travel system may further include output device 51 that outputs the actually traveled course that has been automatically recorded. Thus, courses actually traveled by the work machine may be used for evaluation of each operator's workability, and/or courses actually traveled by the work machine maneuvered by a skilled operator may be used for training of inexperienced operators.

In the embodiments were so far described examples in which automated steering is employed when the work machine travels backward. The work machine may be driven to travel under automated steering during the forward movement. The actually traveled course may also be used as the target travel course of the work machine that travels forward under automated steering. Controller 40 may be allowed to automatically record the actually traveled course during the forward movement under automated steering. Alternatively, controller 40 may avoid automatic recording of the actually traveled course during the forward movement under automated steering which is determined as an already recorded course.

The operator's command issued to start automated steering of the work machine is not necessarily limited to the backward movement of the work machine. The work machine may include an engaging button in the operator's cab, which is used to receive the operator's input to start automated steering. The operator may press the engaging button to start the travel of the work machine under automated steering.

When, for example, the work machine travels forward under manual steering from the travel starting position to the travel ending position and then U-turns and returns to the course actually traveled during the forward movement, the operator may press the engaging button to drive the work machine to travel forward under automated steering.

For example, the operator, who detects any obstacle on the target travel course during the travel under automated steering, may manipulate steering handle 41 to allow the work machine to travel so as to avoid the obstacle. The operator manually handles steering handle 41 to end the travel of the work machine under automated steering and thereafter allows the work machine to travel under manual steering. The course actually traveled under manual steering may also be automatically recorded. When the operator presses the engaging button during the travel under manual steering, automated steering may be restarted.

Accurate knowledge of the work machine's current position may be required to record the actually traveled course. The embodiments disclosed herein described examples in which the satellite positioning system is used to detect the work machine's current position. Instead, a total station installed in a work site may be used to detect the work machine's current position. A SLAM (Simultaneous Localization and Mapping) may otherwise be used to detect the work machine's current position.

All of the embodiments are disclosed herein by way of illustration and example only and should not be construed as limiting by any means the scope of this disclosure. The scope of this disclosure is solely defined by the appended claims and is intended to cover the claims, equivalents, and all of possible modifications made without departing the scope of this disclosure.

### REFERENCE SIGNS LIST

11: operator's cab, 11S: operator's seat, 12, 203: work implement, 16: front wheel, 17: rear wheel, 17L: left rear wheel, 17R: right rear wheel, 18, 202: body frame, 21: blade, 31: handle sensor, 32: operating lever sensor, 34: direction sensor, 34a: IMU, 34b: steering angle sensor, 34c: articulate angle sensor, 35: GNSS receiver, 37: FNR/vehicle speed sensor, 40: controller, 40b: handle operation identifier, 40c: operating lever identifier, 40d: acceleration operation identifier, 40e: travel direction/speed obtainer, 40g: position/orientation identifier, 40h: travel start determiner, 40i: travel stoppage determiner, 40m: timer, 40n: actual travel course recorder, 40p: memory, 40q: target travel course decider, 40r: travel commander, 41: steering handle, 42: operating lever, 51: output device, 52: input device, 54: display device, 56a: acceleration pedal, 56b: acceleration operation detector, 57a: brake pedal, 57b: braking operation detector, 58: travel/stoppage operating unit, 66: steering mechanism, 67: steering operating unit, 72: steering valve, 73: electrofluid pressure control valve, 74: steering cylinder, 81: engine, 82: power transmission apparatus, 100: motor grader, 110, 120: actually traveled course, 110A: travel starting position, 110B, 110C: travel ending position, 130: target travel course, 132: extension, 200: wheel loader, 300: dump truck, 310: target of excavation, OBS: obstacle

1: A travel system for a work machine, comprising:
a traveling apparatus that prompts the work machine to travel; and
a controller that prompts automated recording of an actually traveled course which is a course actually traveled by the work machine.

2: The travel system for a work machine according to claim 1, wherein the controller, based on a command issued by an operator, prompts the work machine to travel under automated steering using the actually traveled course recorded earlier as a target travel course.

3: The travel system for a work machine according to claim 1, wherein
the controller detects that the work machine starts to travel and sets a starting point of the actually traveled course, and
the controller detects that the work machine ceases to travel and sets an ending point of the actually traveled course.

4: The travel system for a work machine according to claim 3, wherein the controller determines that the work machine starts to travel based on forward movement started by the work machine.

5: The travel system for a work machine according to claim 4, wherein the controller determines that the work machine starts to travel based on backward movement started by the work machine.

6: The travel system for a work machine according to claim 3, wherein the controller determines that the work machine starts to travel based on a traveling speed of the work machine being greater than or equal to a threshold.

7: The travel system for a work machine according to claim 3, wherein the controller determines that the work machine starts to travel based on a moving distance of the work machine being greater than or equal to a threshold.

8: The travel system for a work machine according to claim 3, further comprising a memory in which the actually traveled course recorded by the controller is storable, wherein
when a first actually traveled course of the work machine overlaps with the actually traveled course already stored in the memory, the controller determines not to store the first actually traveled course in the memory.

9: The travel system for a work machine according to claim 3, wherein the controller prompts recording of the actually traveled course during a period earlier by a predetermined length of time than a time point when stoppage of the travel of the work machine is detected.

10: The travel system for a work machine according to claim 3, wherein the controller, based on a command issued by an operator, prompts the work machine to travel under automated steering using the actually traveled course recorded earlier as a target travel course.

11: The travel system for a work machine according to claim 10, wherein the controller prompts the work machine to travel under automated steering based on a command issued by an operator requesting backward movement.

12: The travel system for a work machine according to claim 10, further comprising a memory in which a plurality of the actually traveled courses recorded by the controller are storable, wherein
the controller selects the actually traveled course used as the target travel course from the plurality of the actually traveled courses stored in the memory.

13: The travel system for a work machine according to claim 12, further comprising an input device that receives an input from an operator for selection of the actually traveled course used as the target travel course from the plurality of the actually traveled courses stored in the memory.

14: The travel system for a work machine according to claim 10, wherein the controller decides the target travel course including a course obtained by extension of the actually traveled course.

15: The travel system for a work machine according to claim 10, further comprising a display device on which the target travel course is displayable.

16: The travel system for a work machine according to claim 1, further comprising an output device that outputs the actually traveled course recorded earlier.

17: A control method for a work machine, comprising:
prompting the work machine to travel; and
prompting automated recording of an actually traveled course which is a course actually traveled by the work machine.
